(19) United States
(12) Patent Application Publication
(10) Pub. No.: US 2013/0344404 A1
(43) Pub. Date: Dec. 26, 2013

(54) HYBRID HUMIDIFIER FUEL CELL

(71) Applicant: L'AIR LIQUIDE SOCIETE ANONYME POUR L'ETUDE ET L'EX, Paris (FR)

(72) Inventors: Philippe A. COIGNET, Bear, DE (US); Rajeev S. Prabhakar, Wilmington, DE (US)

(73) Assignee: L'Air Liquide Societe Anonyme Pour l'Etude et l'Expoitation des Procedes Georges Claude, Paris (FR)

(21) Appl. No.: 13/678,901

(22) Filed: Nov. 16, 2012

Related U.S. Application Data
(60) Provisional application No. 61/662,693, filed on Jun. 21, 2012.

(51) Int. Cl. H01M 8/04

(52) U.S. Cl. CPC H01M 8/04126
USPC 429/413

(57) ABSTRACT

A hybrid humidifier fuel cell for ensuring adequate humidification of a reactant gas stream in a fuel cell stack, during both steady-state, as well as transient operation. The device provides for improved performance through the use a primary humidification and a secondary humidification.

### RELATED APPLICATIONS

This patent application claims priority to U.S. Provisional Patent Application Ser. No. 61/662,693 filed on Jun. 21, 2012, which is hereby incorporated by reference in its entirety.

### TECHNICAL FIELD OF THE INVENTION

The present invention relates to a method and device for increasing the humidity of gas feed streams to a point above their saturation humidity in order to improve the efficiency of a proton exchange membrane (PEM) fuel cell.

### BACKGROUND OF THE INVENTION

All fuel cells contain two electrodes (an anode and a cathode), an electrolyte, which carries electrically charged particles between the electrodes, and a catalyst. PEM fuel cells use a membrane that is specifically developed to transfer hydrogen ions as the electrolyte. In operation of a PEM fuel cell, hydrogen gas enters the fuel cell at the anode where it makes contact with the catalyst and is separated into free electrons and hydrogen ions. The hydrogen ions are transferred to the cathode side via the exchange membrane and the electrons move from the anode to the cathode via an electrically conductive material (e.g., copper wire) to provide power to a load. Oxygen gas (typically supplied by air) enters the cathode side, where the hydrogen ions, free electrons combine with the oxygen in the presence of a catalyst to form water. The process creates a tiny amount of heat and water as part of the exhaust.

It is known that PEM fuel cells operate more efficiently when the gas feed streams have increased levels of humidity. Therefore, various methods have used humidifiers to add water vapor to the gas streams in order to increase the humidity. Such humidifiers, typically, utilize water or water vapor exiting the fuel cell stack to humidify inlet reactant gas streams, however, the humidifiers may also use water from other sources during situations where adequate water is not available in the fuel cell exhaust streams.

The maximum humidity achievable by these humidifiers is limited to the saturation humidity at the prevailing gas stream temperature. Therefore, to achieve high humidity in the fuel cell stack, the temperature of the inlet streams, humidifier, tubing, and gas supply manifold must be maintained close to the fuel cell stack temperature. Under steady-state operation (i.e., when enough time has been provided for heating the inlet gas stream, humidifier, tubing, and gas supply manifold to the desired temperature), the primary humidifier can provide adequate humidification to the fuel cell stack.

However, during fuel cell start-up, due to the large heat capacity of the humidifier, tubing and manifold, the reactant gas streams remain cooler than the stack temperature. As a result, upon entering the stack, the reactant gas streams' temperatures increase due to heat exchange with the hotter stack, which thereby decreases the relative humidity of the streams. The extent of lowering of relative humidity depends on the difference between the inlet gas stream temperature and the stack temperature. Therefore, the polymeric membranes are likely to experience low relative humidity during this non-steady state condition, leading to an overall reduction in efficiency. Additionally, operation at low relative humidity is strongly suspected to impact the durability of some membranes. Therefore, inadequate humidity during start-up can affect both membrane performance and lifetime.

Another problem with previously known humidifiers is that they are designed for stationary operations and work optimally for a given range of flow rates. As such, they usually do not ensure proper humidification over an entire range of flow rates encountered during operation.

Therefore, there is clearly a need for a humidification system that (i) covers the whole range of flow rates and (ii) has a shorter response time to changing fuel cell conditions such as during start-ups and transient operation than current humidifiers.

### SUMMARY OF THE INVENTION

The present invention is directed to a device and a method that satisfies at least one of these needs. Certain embodiments of the present invention relate to the use of a hybrid humidifier in which a nebulization system is used to supplement the humidity provided by a primary humidifier, particularly during start-ups and transient operation, in order to achieve the desired humidity in the fuel cell stack.

In one embodiment, the hybrid humidifier can include a primary humidification system that introduces water vapor into the inlet streams, and a nebulization system that provides additional moisture to the inlet streams in the form of tiny micro-, or sub-micro-droplets, when the primary humidifier is not able to provide the desired relative humidity inside the fuel cell stack. Such a scenario can occur, for example, during start-up, transient operation or when the primary humidifier is operated outside its optimal working range.

In one embodiment, a method for humidifying a fuel stream to be supplied to a polymer exchange membrane (PEM) fuel cell is provided. In this embodiment, the PEM fuel cell can have an anode, a cathode and a PEM. The method can include the steps of:
a) introducing water vapor into an oxygen containing gas stream using a first primary humidifier to form a humidified oxygen stream, wherein the humidified oxygen stream contains up to 100% relative humidity at a temperature T₀;
b) introducing water vapor into a hydrogen containing gas stream using a second primary humidifier to form a humidified hydrogen stream wherein the humidified hydrogen stream contains up to 100% relative humidity;
c) introducing water into the humidified oxygen stream using a first secondary humidifier, wherein the water introduced in step c) comprises water droplets that are operable to be suspended in the humidified oxygen stream thereby forming a super-humidified oxygen stream;
d) introducing water into the humidified hydrogen stream using a second secondary humidifier, wherein the water introduced in step d) comprises water droplets that are operable to be suspended in the humidified oxygen stream thereby forming a super-humidified hydrogen stream;
e) introducing the super-humidified oxygen stream to the cathode; and
f) introducing the super-humidified hydrogen stream to the anode such that the PEM fuel cell is operable to provide power to a load.

In one embodiment, the water droplets introduced in step c) and step d) are sufficiently small such that the water droplets do not coalesce. In another embodiment, the water droplets introduced in step c) and step d) are micro-droplets. In another embodiment, the water droplets introduced in step c) are operable to vaporize into the super-humidified oxygen stream at a temperature T₁, wherein T₁ is greater than T₀, such that the super-humidified oxygen stream has a relative humidity of up to 100%. In another embodiment, the water droplets introduced in step c) are operable to vaporize into the super-humidified oxygen stream at a temperature T₁, wherein T₁ is greater than T₀, such that the super-humidified oxygen stream is fully saturated with water vapor.

In another embodiment, the method can include the steps of measuring a first temperature using a first temperature probe, wherein the first temperature probe is configured to measure the first temperature at a point selected from the group consisting of the anode, the cathode, and a combination thereof; and measuring a second temperature using a second temperature probe, wherein the second temperature is measured at a point upstream the secondary humidification system. In another embodiment, the method can include the step of adjusting the amount of water introduced in step c) and step d) based on the first temperature and the second temperature.

In another embodiment, the amount of water introduced in step c) and step d) is increased when the first temperature is greater than the second temperature. In another embodiment, the amount of water introduced in s step c) and step d) is decreased when the first temperature is not greater than the second temperature.

In another aspect of the invention a hybrid humidifier fuel cell is provided which can include a primary humidification system configured to introduce water vapor to a gas stream to form a humidified gas stream, such that the humidified gas stream contains up to 100% relative humidity at a temperature T₀; a secondary humidification system configured to introduce water droplets into the humidified gas stream, wherein the water droplets are operable to be suspended in the humidified gas stream thereby forming a super-humidified gas stream; and a fuel cell having a cathode, an anode, and a PEM, wherein the fuel cell is configured to receive the super-humidified gas stream.

In another embodiment, the hybrid humidifier fuel cell can include a first temperature probe and a second temperature probe, the first temperature probe configured to measure the temperature of the fuel cell, the second temperature probe configured to measure the temperature of the humidified gas stream at a point upstream the secondary humidification system. In another embodiment, the hybrid humidifier fuel cell can also include a controller configured to activate the secondary humidification when the measured temperature from the first temperature probe is higher than the measured temperature from the second temperature probe. In an optional embodiment, the controller can be configured to deactivate the secondary humidification when the measured temperature from the first temperature probe is not higher than the measured temperature from the second temperature probe.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows a hybrid humidifier fuel cell in accordance with an embodiment of the invention.

FIG. 2 shows a hybrid humidifier fuel cell in accordance with an embodiment of the invention.

FIG. 3 shows a hybrid humidifier fuel cell in accordance with an embodiment of the invention.

### DETAILED DESCRIPTION

While the invention will be described in connection with several embodiments, it will be understood that it is not intended to limit the invention to those embodiments. On the contrary, it is intended to cover all the alternatives, modifications and equivalence as may be included within the spirit and scope of the invention defined by the appended claims.

Humidifiers or humidification systems can broadly be classified into two categories: (i) those that humidify a stream by adding water vapor (i.e., gaseous water) into the stream, and (ii) those that humidify a stream by adding tiny water droplets (i.e., liquid water) into a stream.

### Primary Humidifiers

Humidifiers or humidification systems that humidify a stream by adding water vapor into the stream are referred to herein as primary humidifiers. Primary humidifiers can humidify a stream only up to its saturation humidity at the prevailing temperature of the gas stream. Some primary humidifiers may also add water droplets into the gas stream in certain operating conditions. However, these water droplets are large in size and therefore difficult to vaporize quickly by absorbing heat from the surroundings (i.e., the water droplets cannot provide the water necessary to increase the relative humidity when the gas temperature increases at the fuel cell stack). Also, the size and amount of water droplets added into the gas stream in this manner cannot be easily controlled, and therefore, the resulting humidity of the gas stream cannot be easily controlled or predicted. In addition, from the fuel cell perspective, if such large water droplets enter the fuel cell stack, they can cause flooding in the fuel cell stack and reduce fuel cell performance.

In one embodiment, the primary humidifier can be a membrane-based humidifier that selectively transfers water from the wet exhaust stream(s) of the fuel cell to the dry inlet stream(s) of the fuel cell. In another embodiment, the primary humidification system could condense water vapor exiting the fuel cell and introduce it into the inlet stream either by (i) bubbling the inlet gas stream through the water, or (ii) re-evaporating the water and introducing it into the inlet streams as water vapor. In another embodiment, the primary humidifier might also humidify the inlet streams by mixing all or part of the corresponding exhaust stream with the inlet stream. For example, by mixing all or part of the exhaust hydrogen stream with the inlet hydrogen stream, one can humidify the inlet hydrogen stream, thus increasing the utilization rate of the fuel. Such a process is known as hydrogen recirculation

### Nebulizing Humidifiers

Humidifiers belonging to the second category described above work by nebulizing liquid water into controlled amounts of tiny water droplets of controlled size and adding the droplets to the gas stream. For example, an ultrasonic nebulizer can generate water droplets using ultrasonic vibrations.

The nebulizer introduces water into a gas stream as tiny micron- or sub-micron-sized droplets (collectively called micro-droplets, henceforth), which evaporate quickly by absorbing heat from the surroundings due to their high surface area. In the hybrid humidifier, the nebulizer introduces micro-droplets into the inlet reactant gas streams right before the gases enter the stack. Once inside the stack, the micro-droplets evaporate quickly and provide higher relative humidity. By controlling the amount of micro-droplets introduced into the gas as well as the droplet size, desired relative humidity can be achieved within the stack. In one embodiment, the nebulizer can include an ultrasonic mist maker, but any type of nebulization technology can be used, the key being to introduce micro-droplets of water that can be suspended within the flow of gas into the stack.

The nebulizer also helps to provide adequate humidity outside the optimal operating range of the primary humidifier and hence extends the operational range of the humidification system.

In one embodiment, the nebulizer can be configured to allow for fine relative humidity control using simple process control loops. For example, the temperature of the stack can be measured and compared to the temperature of the incoming air to be humidified, and when the stack temperature has increased, the secondary humidification system can be activated to assure that enough water is in the air reaching the fuel stack in order to keep it properly humidified. Advantageously, the production of mist is quasi-instantaneous compared to the stack-temperature dynamic. Moreover, the size of the micro-droplets can be finely controlled to optimize vaporization within the stack.

Various configurations of the hybrid humidifier are possible. For example, the nebulizer can be connected in series, in parallel or in a by-pass configuration with the primary humidifier. FIGS. 2(a-c) show schematic diagrams of these configurations. These diagrams are just examples and are therefore not restrictive.

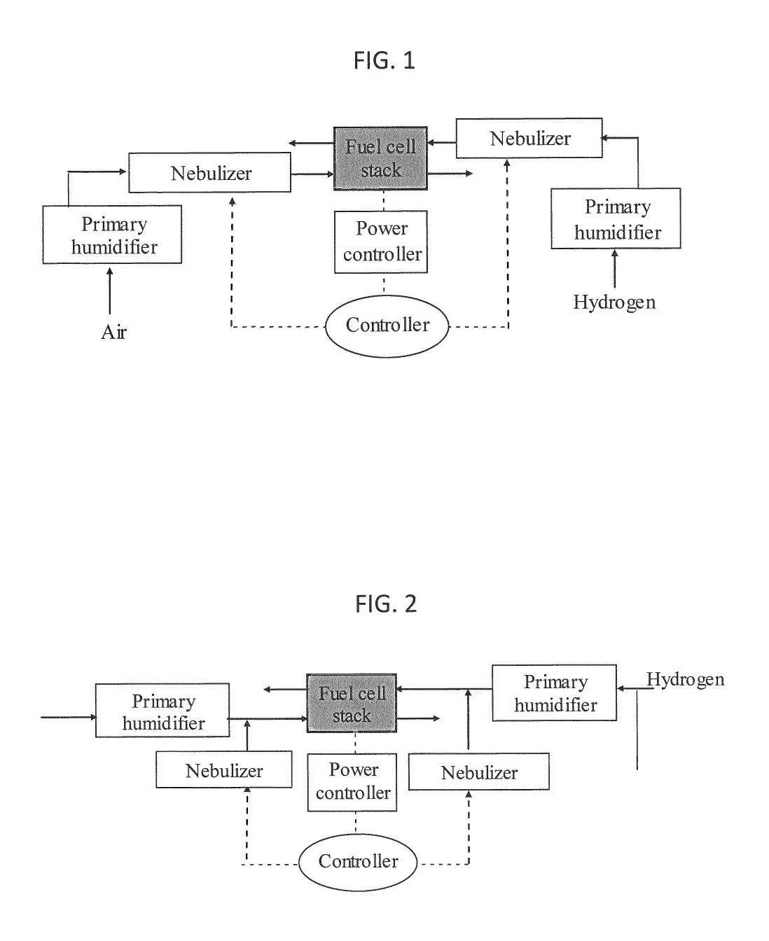

FIG. 1: A fuel cell humidification system in which both the hydrogen and air streams are humidified by hybrid humidifiers, each having a nebulizer connected in series with a primary humidifier.

FIG. 2: A fuel cell humidification system in which both the hydrogen and air streams are humidified by hybrid humidifiers, each having a nebulizer connected in parallel with a primary humidifier.

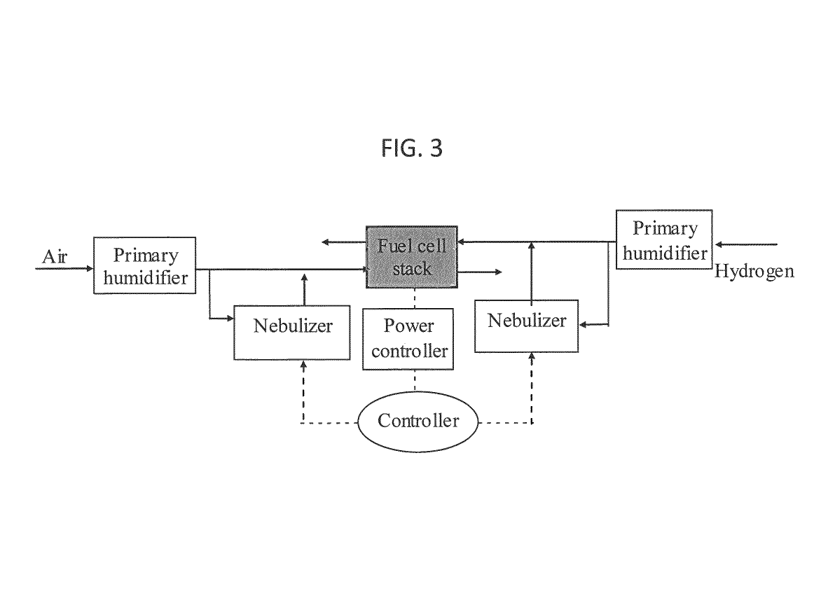

FIG. 3: A fuel cell humidification system in which both the hydrogen and air streams are humidified by hybrid humidifiers, each having a nebulizer connected in a by-pass configuration with a primary humidifier.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, language referring to order, such as first and second, should be understood in an exemplary sense and not in a limiting sense. For example, it can be recognized by those skilled in the art that certain steps or devices can be combined into a single step/device.

The singular forms “a”, “an”, and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A hybrid humidifier fuel cell comprising:
a primary humidification system configured to introduce water vapor to a gas stream to form a humidified gas stream, such that the humidified gas stream contains up to 100% relative humidity at a temperature T₀;
a secondary humidification system configured to introduce water droplets into the humidified gas stream, wherein the water droplets are of sufficient size to be suspended in the humidified gas stream thereby forming a super-humidified gas stream; and
a fuel cell having a cathode, an anode, and a PEM, wherein the fuel cell is configured to receive the super-humidified gas stream.

2. The hybrid humidifier fuel cell as claimed in claim 1, wherein the gas stream is selected from the group consisting of an oxygen containing gas stream, a hydrogen containing gas stream, and combinations thereof.

3. The hybrid humidifier fuel cell as claimed in claim 1, wherein the water droplets introduced by the secondary humidification system are sufficiently small such that the water droplets do not coalesce.

4. The hybrid humidifier fuel cell as claimed in claim 1, wherein the water droplets introduced by the secondary humidification system are micro-droplets.

5. The hybrid humidifier fuel cell as claimed in claim 1, wherein the water droplets introduced by the secondary humidification system are operable to vaporize into the super-humidified gas stream at a temperature T₁, wherein T₁ is greater than T₀, such that the super-humidified gas stream has a relative humidity of up to 100% at temperature T₁.

6. The hybrid humidifier fuel cell as claimed in claim 1, wherein the water droplets introduced by the secondary humidification system are operable to vaporize into the super-humidified gas stream at a temperature T₁, wherein T₁ is greater than T₀, such that the super-humidified gas stream is fully saturated with water vapor at temperature T₁.

7. The hybrid humidifier fuel cell as claimed in claim 1, further comprising a first temperature probe and a second temperature probe, the first temperature probe configured to measure the temperature of the fuel cell, the second temperature probe configured to measure the temperature of the humidified gas stream at a point upstream the secondary humidification system.

8. The hybrid humidifier fuel cell as claimed in claim 7, further comprising a controller configured to activate the secondary humidification when the measured temperature from the first temperature probe is higher than the measured temperature from the second temperature probe.

9. The hybrid humidifier fuel cell as claimed in claim 7, further comprising a controller configured to deactivate the secondary humidification when the measured temperature from the first temperature probe is not higher than the measured temperature from the second temperature probe.
